(19) United States
(12) Patent Application Publication
(10) Pub. No.: US 2006/0102756 A1
(43) Pub. Date: May 18, 2006

(54) ADJUSTABLE SPRAY APPLICATOR FOR VEHICLE WASHING APPLICATIONS

(75) Inventors: Douglas Calvin, Livonia, MI (US); Lionel Belanger, Northville, MI (US)

Correspondence Address: ARTZ & ARTZ, P.C., 28333 TELEGRAPH RD., SUITE 250, SOUTHFIELD, MI, 48034, US

(73) Assignee: Lionel Belanger, Northville, MI (US)

(21) Appl. No.: 11/163,805

(22) Filed: Oct. 31, 2005

Related U.S. Application Data
(60) Provisional application No. 60/623,385, filed on Oct. 29, 2004.

(51) Int. Cl. B05B 15/08

(52) U.S. Cl. 239/587.3; 239/587.1; 239/587.2; 239/548

(57) ABSTRACT

A manually adjustable spray applicator includes a nozzle, a supply conduit, and a flexible coupling that attaches the nozzle to the supply line. The supply conduit is in communication with a supply of fluid or gas at a first end and is connected to the flexible coupling at a second end. The nozzle includes a plurality of orifices formed therein to emit fluid or gas received through the supply line. The flexible coupling provides for at least one point of adjustment that allows the applicator to be moved through multiple degrees of freedom to a virtually unlimited number of positions. The flexible coupling allows an operator to manually adjust the flexible coupling without the need for any tools and without the need to stop the flow of fluid through the applicator.

### CROSS-REFERENCE TO RELATED APPLICATIONS

The present application claims priority from U.S. Provisional Application Ser. No. 60/623,385 filed Oct. 29, 2004 and entitled “Adjustable Spray Application For Vehicle Washing Applications.”

### TECHNICAL FIELD

The present invention relates generally to a manually adjustable spray applicator, and more particularly to a manually adjustable spray applicator for vehicle washing applications.

### BACKGROUND OF THE INVENTION

Spray applicators are well known and are utilized for a variety of uses and purposes and are most commonly used to spray water. Adjustable spray applicators for varying or changing the direction from or location to which fluid from an attached nozzle is emitted are also known. However, these adjustable spray applicators are limited in the applications to which they can be applied. Moreover, the adjustment process for these applicators can be relatively cumbersome and does not always result in precise or stable positioning of the attached nozzle.

Spray applicators are also utilized in vehicle washing applications, as is well known in the art. These spray applicators emit various types of fluid, including foam solutions, such as for soaping a vehicle, or water for rinsing a vehicle. These spray applicators are oriented to spray the fluid over particular portions of a vehicle, as the vehicle is being conveyed past the applicators or as the applicators are moved with respect to a vehicle. Many of these applicators are also adjustable.

However, current adjustable spray applicators that are utilized for vehicle washing applications are also relatively cumbersome to adjust and suffer from a variety of other disadvantages. For example, many adjustable spray applicators currently used in vehicle washing applications require an operator to use a tool or tools to effectuate the adjustment process. This is because the nozzles are connected to a supply line by an attachment mechanism, such as a lock nut or other similar mechanism. The attachment mechanism locks the spray applicator and keeps it from moving after set in a certain position by the operator. Any undesirable moving would change the direction of the fluid flow and require the operator to readjust the position of the applicator. Additionally, other attachment mechanism allow for the adjustment through the use of loosening a nut, collar or the like, however, these still require an additional step.

In order to change the direction of fluid flow with these adjustable spray nozzles, an operator requires a mechanical tool to loosen the lock nut or other similar mechanism to unlock the nozzle. Once the nozzle is unlocked, the operator can adjust its orientation as desired to direct the fluid flow to another position. Once the nozzle is adjusted to the desired position to direct flow in a particular area, the operator must utilize the tool to tighten the lock nut or other mechanism and lock the nozzle in that position. This process is relatively time consuming and particularly so when the operator must adjust multiple applicators by repeating the same process multiple times. Moreover, these adjustable spray applicators are relatively limited in the number of orientations to which they can be adjusted.

Additionally, with most current applicators, they must be shut off in order to adjust their positions. This is because the applicators do not work when the adjustment mechanism has been loosened or leaks severely and sprays fluid in a variety of different directions. Further, because the applicators are shut off during the adjustment process, the operator cannot get feedback as to the fluid direction location until the system is turned back on. Accordingly, if after adjustment, the applicators are not oriented in the proper location, the operator may have to readjust one or more of the applicators after they have been turned back on by shutting the system down again. Alternatively, the vehicle wash system will operate with non-optimum applicator locations for a given period of time.

FIG. 1 illustrates another example of a coupling for an adjustable spray applicator currently used in vehicle wash applications. The coupling 1 has a fluid inlet 3, which communicates with a supply line (not shown). The coupling 1 also has one or more fluid outlets 5 into which nozzles (not shown) are threadably connected to emit fluid from the applicator. In order to adjust the orientation of the applicator, a locking nut 7 on the end of the coupling 1 typically must be loosened to allow the fluid outlet 5 to be moved. However, the movement of the nozzles in the fluid outlets 5 is limited as they can only move about a single axis. Specifically, they can only rotate about an axis through the centerline (C_{L}) of the coupling to allow the nozzle to be moved upwardly and downwardly only.

Therefore, a need exists for a spray applicator that can be readily adjusted without the need for tools and therefore significantly decreases the time required for adjustment. Additionally, a need exists for a manually adjustable spray applicator that allows the fluid emitted therethrough to be directed in an increased number of locations and directions. Further, a need exists for a manually adjustable applicator that provides an operator with immediate feedback as to the direction of flow emitted from the applicator.

### SUMMARY OF THE INVENTION

One advantage of the present invention is to provide a spray applicator for vehicle wash applications that is manually adjustable to redirect the fluid flow emitted therefrom.

It is a related advantage of the present invention is to provide a spray applicator for vehicle wash applications that is manually adjustable to redirect the fluid flow therefrom without the need for any tools.

It is another advantage of the present invention to provide a spray applicator for vehicle wash applications that is manually adjustable to change both the position and the angle of an attached nozzle about multiple degrees of freedom to provide a virtually unlimited number of spray orientations.

It is a further advantage of the present invention is to provide a manually adjustable spray applicator for vehicle wash applications that allows for increased efficiency and productivity of the vehicle wash process.

It is yet another advantage of the present invention to provide a manually adjustable spray applicator for vehicle wash applications that allows for adjustment without the need to cease operation of the applicator or associated wash application.

It is yet a further advantage of the present invention to provide a manually adjustable spray applicator for vehicle wash applications that allows an operator to receive immediate feedback as to the direction of the fluid flow emitted from the applicator.

In accordance with the above and the other advantages of the present invention, a manually adjustable spray applicator is provided. The spray applicator includes a nozzle, a rigid supply conduit, and a flexible coupling that attaches the nozzle to the supply line. The supply conduit is in communication with a supply of fluid or gas at a first end and is connected to the flexible coupling at a second end. The nozzle includes an inlet, which is connected to a second end of the flexible coupling, and a front face. The nozzle includes at least one orifice formed therein to emit fluid or gas received through the supply line from the supply. The flexible coupling provides for at least one point of adjustment that allows the applicator to be moved through multiple degrees of freedom to a virtually unlimited number of positions. An operator can manually adjust the flexible coupling without the need for any tools and without the need to stop the flow of fluid through the applicator.

Other advantages of the present invention will become apparent when viewed in light of the detailed description of the preferred embodiment when taken in conjunction with the attached drawings and appended claims.

### BRIEF DESCRIPTION OF THE DRAWINGS

For a more complete understanding of this invention, reference should now be made to the embodiments illustrated in greater detail in the accompanying drawings and described below by way of examples of the invention:

FIG. 1 is a perspective view of a prior art coupling of a spray applicator for use in vehicle wash applications.

FIG. 2 is a perspective view of an adjustable spray applicator, in accordance with one embodiment of the present invention.

FIG. 3 is another perspective view of the adjustable spray applicator of FIG. 2.

FIG. 4 is a perspective view of an adjustable spray applicator in one adjusted position in accordance with one embodiment of the present invention.

FIG. 5 is another perspective view of the adjustable spray applicator of FIG. 4.

FIG. 6 is a perspective view of an adjustable spray applicator in another adjusted position in accordance with one embodiment of the present invention.

FIG. 7 is another perspective view of the adjustable spray applicator of FIG. 6.

FIG. 8 is a perspective view of an adjustable spray applicator in yet another adjusted position in accordance with one embodiment of the present invention.

FIG. 9 is a perspective view of an adjustable spray applicator in still another adjusted position in accordance with one embodiment of the present invention.

FIG. 10 is a perspective view of an adjustable spray applicator in a further adjusted position in accordance with one embodiment of the present invention.

FIG. 11 is a perspective view of an adjustable spray applicator in still a further adjusted position in accordance with one embodiment of the present invention.

FIG. 12 is a perspective view of a plurality of spray applicators in accordance with one embodiment of the present invention.

FIG. 13 is a perspective view illustrating the operation of a plurality of spray applicators in accordance with one embodiment of the present invention.

FIG. 14 is a perspective view of a rain arch having a pair of adjustable spray applicators for a vehicle wash applications in accordance with one embodiment of the present invention.

FIG. 15 is a perspective view of an adjustable spray applicator in accordance with another embodiment of the present invention.

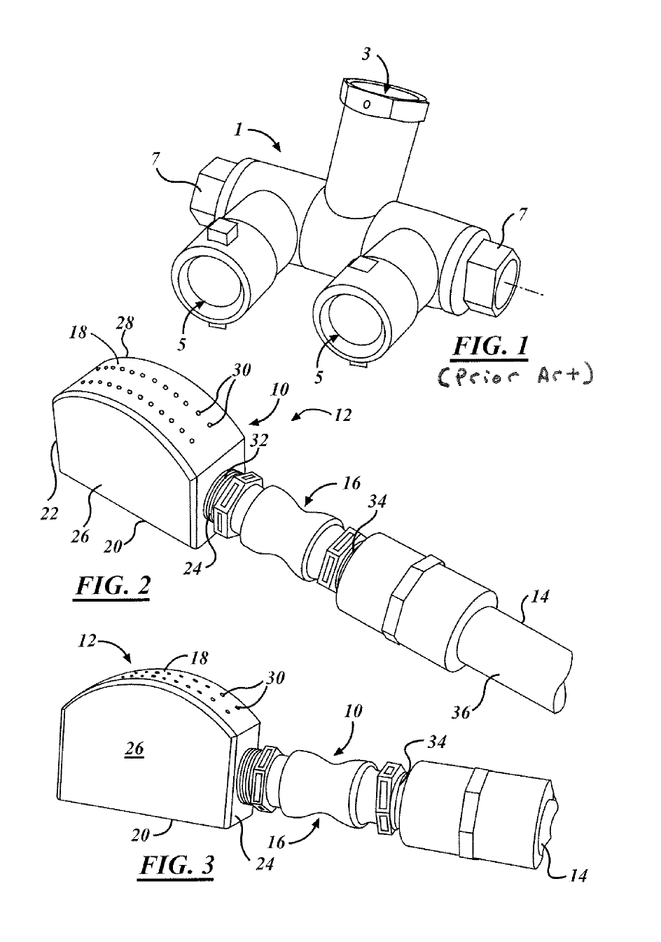

### DETAILED DESCRIPTION OF THE INVETION

Referring now to the Figures, which illustrate an adjustable spray applicator in accordance with the present invention. The adjustable spray applicators disclosed herein are preferably utilized in connection with vehicle washing applications. However, it will be understood that the disclosed adjustable spray applicators can be utilized for a variety of different purposes. Further, the disclosed adjustable spray applicators can be utilized to adjust the flow of a variety of different fluids that are emitted therefrom, including foam and water. However, the disclosed application can also be used in vehicle wash applications to emit gas such as forced air for drying operations. Moreover, the disclosed adjustable spray applicator can be utilized for a variety of different purposes and can take on a variety of different configurations.

FIGS. 2 and 3 illustrate one embodiment of an adjustable spray applicator 10 including a nozzle 12, a rigid supply conduit 14, and a flexible coupling 16. The flexible coupling 16 is manually adjustable and connects the nozzle 12 to the supply conduit 14. The applicator 10 is preferably formed of a plastic material. However, it will be understood that the applicator 10 may be formed of other suitable materials and that it may take on a variety of different shapes and configurations. While the term flexible is used to refer to the coupling, flexible means that the coupling allows for relative movement of attached components.

The nozzle 12 has a front face 18, a back face 20, a top surface 22, a bottom surface 24, and a pair of opposing side surfaces 26, 28. The front face 18 is preferably oriented such that is convex. In other words, the middle portion of the front face 18 is disposed further outwardly from the back face 20 than both the upper and lower portions of the front face 18. The front face 18 has a plurality of openings 30 formed therein through which a fluid or gas is emitted. The nozzle 12 has an inlet 32 formed in its bottom surface 22. It will also be appreciated that the fluid inlet 32 can be formed in a variety of different faces or sides of the nozzle 12. Moreover, the nozzle can take on a variety of different configuration and have only a single orifice or multiple orifices.

It will be understood that the directional terms used herein, including “upper,” “lower,” “top,” and “bottom,” are used for purposes of illustration only and are not intended to be limiting as the applicator 10 and the nozzle 12 can be positioned in a variety of different orientations.

The supply conduit 14 is preferably rigid and has an elongated configuration with a lower end (not shown) and an upper end 34. The lower end of the supply conduit 14 is in communication with a fluid supply (not shown). The lower end of the supply conduit 14 is releasably coupled to the fluid supply so that different types of fluids can be supplied to the applicator as needed. For example, the supply conduit 14 can be coupled to a foaming solution or to water as desired depending upon the application. In the event the supply conduit 14 is connected to a foam solution, a foam generator 36 is disposed within the supply conduit. The supply conduit 14 includes a fluid outlet 38 located at the upper end 34. It will be understood that the fluid conduit 14 can take on a variety of different configurations and shapes. Further, the fluid conduit 14 can be formed of a variety of different materials and may be flexible.

The flexible coupling 16 is disposed between the nozzle 12 and the supply conduit 14. The flexible coupling 16 is connected at an upper end to the fluid inlet 32 of the nozzle head 12. This connection is preferably accomplished by a threaded connection as is well known in the art. However, any other suitable connection method may be utilized. The flexible coupling 16 is connected at a lower end to the fluid outlet 38 of the supply conduit 14. This connection is also preferably accomplished by a threaded connection as is well known in the art. However, any other suitable connection method may be utilized.

The flexible coupling 16 is preferably an adjustable ball fitting. It will be understood that other couplings that allow for manual adjustment may also be utilized. This flexible coupling 16 provides adjustable positioning of the nozzle 12 for more exact and precise control of the direction of the spray of fluid emitted therethrough. This also allows an operator to accurately locate the nozzle 12 as desired without disturbing pipe connections. This also occurs without the need for the utilization of tools or loosening of any type of collar, clamp or nut

The flexible coupling 16 illustrated in FIGS. 2 and 3 has a first point of adjustment 40 and a second point adjustment 42. These points of adjustment 40, 42 can each be individually and independently manually adjusted through multiple degrees of freedom. A sleeve 44 connects the first and second points of adjustment 40, 42. In one embodiment, the first point of adjustment 40 and the second point of adjustment 42 each consist of a ball fitting disposed within a respective end of the sleeve 44. This configuration allows the ball fittings to pivot or move to a virtually unlimited number of positions and orientations. In the unadjusted position shown in FIGS. 2 and 3, the sleeve 44 is oriented in a generally vertical direction. The flexible coupling 16 is rigid enough to support the nozzle 12. The supportive nature of the flexible coupling 16 and the ability of each point of adjustment to be individually manipulated through multiple degrees of freedom allows an operator to orient the nozzle 12 in a virtually unlimited number of positions. The flexible coupling 16 shown in FIGS. 2 and 3 is in a normal unadjusted position where the centerline of the inlet 32 lines up with the centerline of the supply conduit 14. While the flexible coupling 16 illustrated in FIGS. 2 and 3 includes two points of adjustment, it will be understood that it may only include a single point of adjustment or may include more than two points of adjustment.

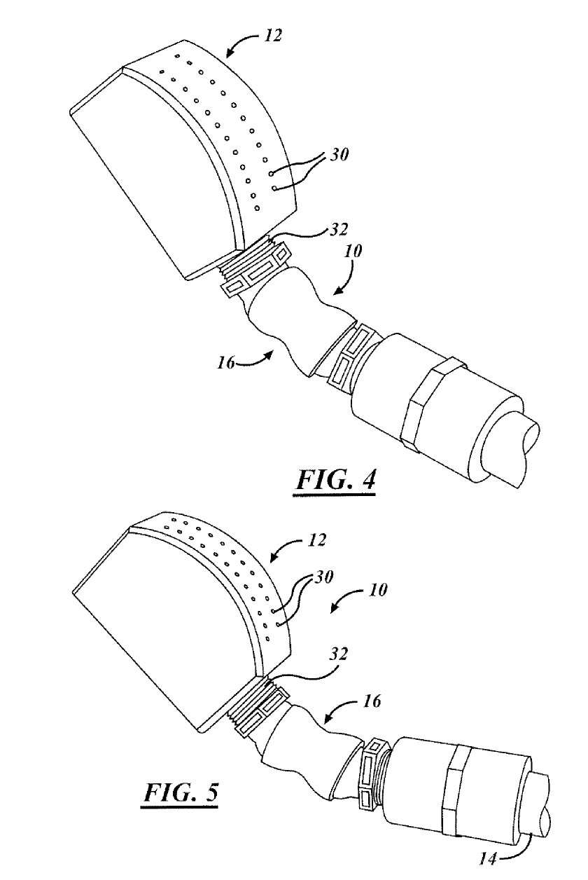

FIGS. 4 though 111 illustrate the applicator 10 in various positions. Specifically, FIGS. 4 and 5 illustrate the applicator 10 in a generally forwardly adjusted position where the nozzle 12 is manipulated forward. As shown in FIGS. 4 and 5, the first and second points of adjustment 40, 42 are manipulated forwardly to direct the spray in a generally downward direction. As also shown, the sleeve 44 is angled generally forward from its unadjusted vertical position.

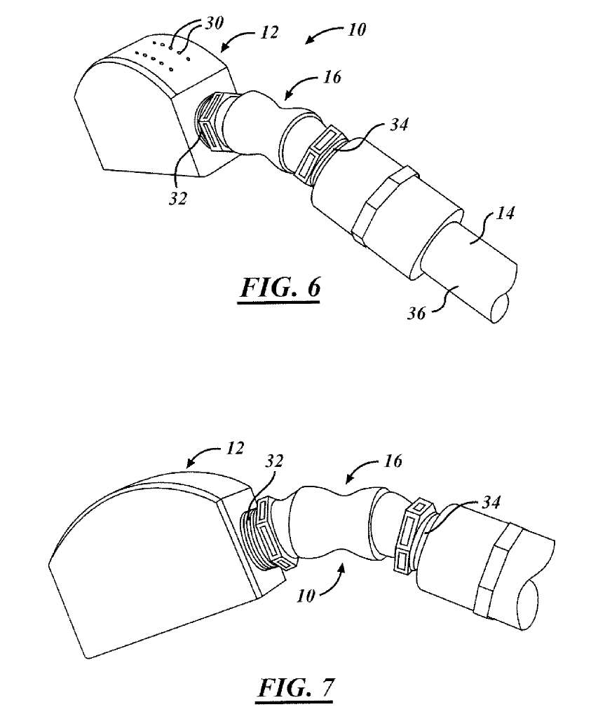

FIGS. 6 and 7 illustrate the applicator 10 in an adjusted position where the nozzle 12 is moved generally rearwardly. As shown in FIGS. 6 and 7, the first and second points of adjustment 40, 42 are manipulated rearwardly to direct the spray in a generally upward direction. As also shown, the sleeve 44 is angled generally rearwardly from its unadjusted vertical position.

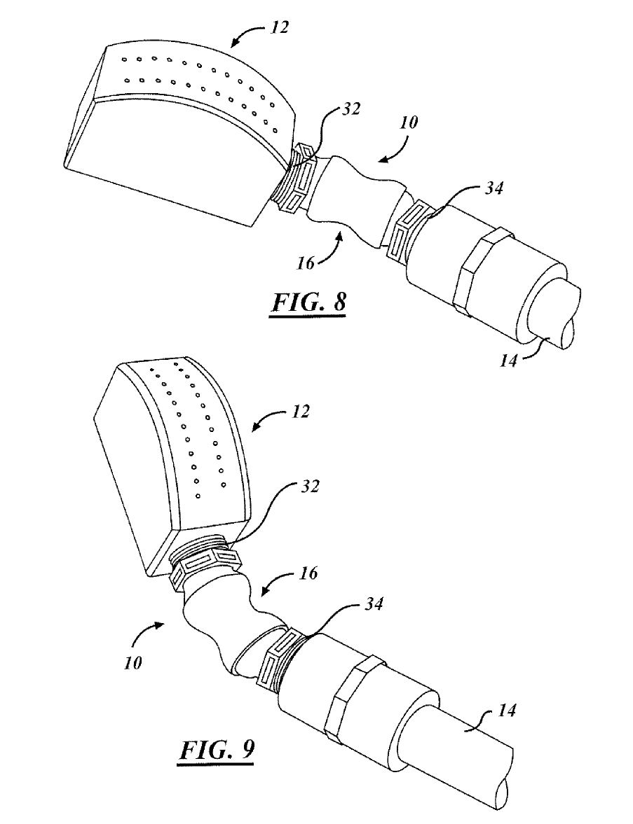

FIG. 8 illustrates the applicator 10 in a position where the nozzle 12 is adjusted generally sideways. In this position, the first and second points of adjustment 40, 42 are manipulated to one side to direct the spray in an angled direction. As also shown, the sleeve 44 is angled generally to one side from its unadjusted vertical position.

FIG. 9 illustrates the applicator 10 in a position where the nozzle 12 is adjusted to an opposing position from that illustrated in FIG. 8. In this position, the first and second points of adjustment 40, 42 are manipulated to the other side from that illustrated in FIG. 8 to direct the spray in an opposing direction. As also shown, the sleeve 44 is angled generally to the other side from its unadjusted vertical position.

FIG. 10 illustrates the applicator 10 in an adjusted position where the nozzle 12 is manipulated rearwardly and sideways. In this position, the first and second points of adjustment 40, 42 are manipulated to the side and to the rear to direct the spray in an upward and angled direction. As also shown, the sleeve 44 is angled generally rearwardly and to one side from its unadjusted vertical position.

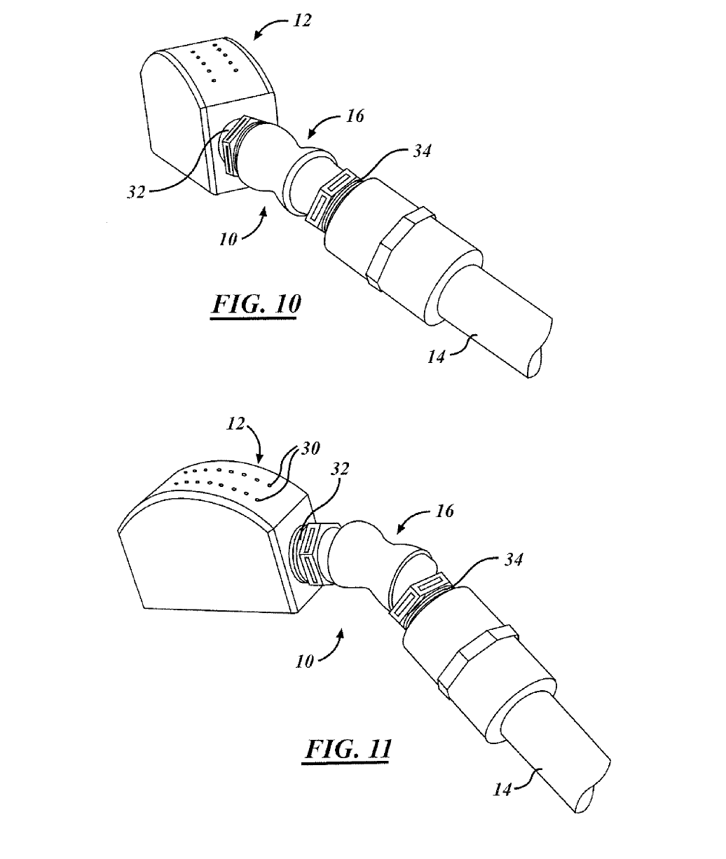

FIG. 11 illustrates the applicator 10 in another adjusted position where the nozzle 12 is manipulated rearward and sideways. In this position, the first and second points of adjustment 40, 42 are manipulated to the side and to the rear to direct the spray in an upward and angled direction. As also shown, the sleeve 44 is angled generally rearwardly and to one side from its unadjusted vertical position.

The inclusion of the flexible coupling 16 allows the nozzle 12 to be readily adjusted when desired. For example, when the applicator 10 with the disclosed flexible coupling 16 is utilized in vehicle wash applications, under certain instances, the nozzle 12 requires adjustment, such as where the speed of the conveyer line changes or when the water or air pressure changes. In those instances, the disclosed flexible coupling 16 can be manually adjusted through multiple degrees of freedom to allow an operator to compensate for these conditions as well as others that may occur during normal vehicle wash applications. Additionally, the disclosed flexible coupling 16 allows the applicator 10 to be adjusted on the fly while the vehicle wash system is operating. Further, the operator can adjust the position of the applicator 10 without having to interrupt the fluid supply therethrough. Moreover, because the fluid supply continues through the nozzle 12, the operator is able to receive immediate feedback as to the location of fluid spray emitted therefrom to insure that the spray is directed into contact with the desired surfaces and is properly oriented. Additionally, because the seal of the nozzle is not disturbed or broken during the adjustment process, the operator does not get sprayed with fluid if the applicator 10 is adjusted while fluid flows therethrough.

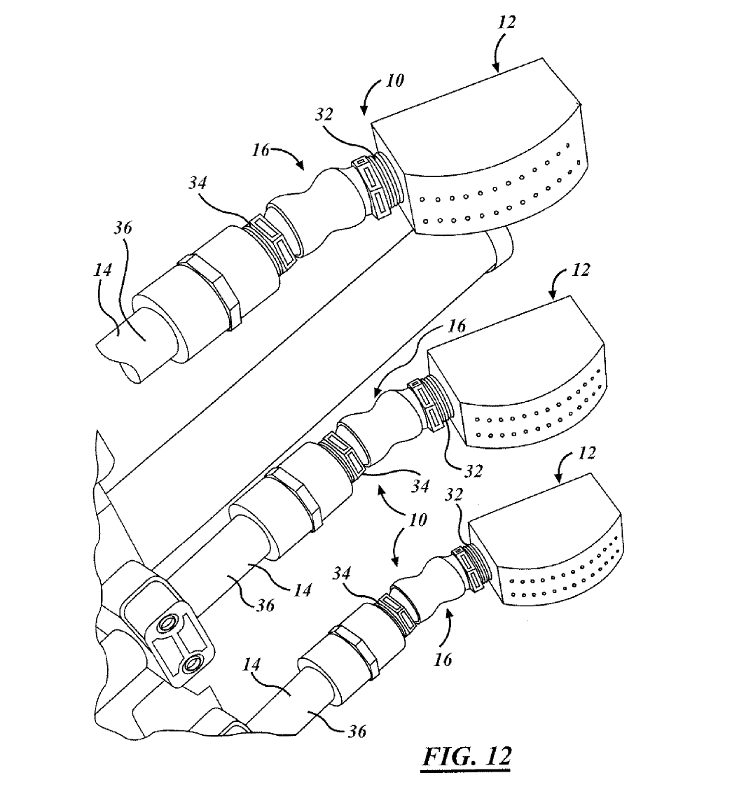

As will also be appreciated in vehicle wash applications, multiple applicators 10 may be utilized to emit a fluid or gas onto a vehicle. In this instance, multiple applicators 10 are connected to a single manifold (not shown). FIG. 12 illustrates one example of a plurality of applicators 10 connected to a single manifold. Each of the applicators 10 includes a nozzle 12, a supply conduit 14, and a flexible coupling 16. As shown, each of these supply conduits 14, includes a foam generator 36. Further, each of the supply conduits 14 and the flexible couplings 16 are rigid enough to support the attached nozzle 12. Additionally, the flexible couplings 16 allow the nozzles 12 to be manually adjusted independently such that their angle and height can be varied or changed to provide a virtually unlimited number of positions. The utilization of a plurality of applicators 10 provides significant advantages because the nozzles 12 can each be manually adjusted without the need for any tools and also because the nozzles 12 can be quickly and properly oriented in the same fashion discussed above.

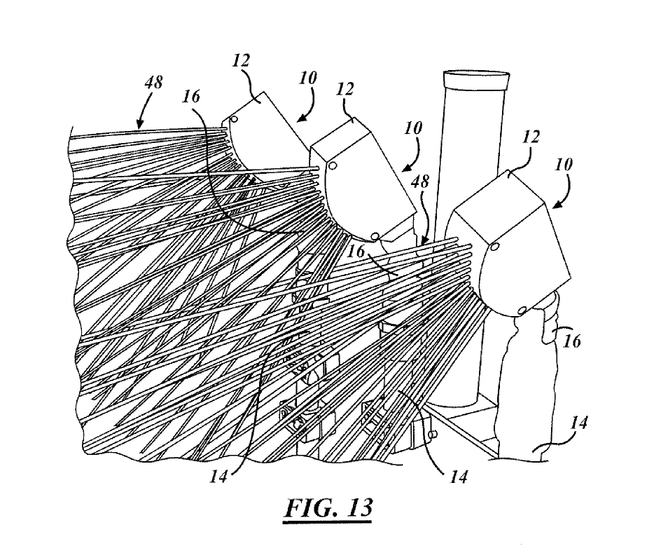

FIG. 13 illustrates a plurality of applicators 10 oriented in a similar fashion as shown in FIG. 12. However, the applicators 10 in FIG. 13 are emitting a fluid. In operation, a foam solution, such as a chemical and water solution, is supplied to the supply conduit 14. The solution is foamed in the foam generator 36 before being conveyed to the nozzle 12 and being emitted through the plurality of openings 30. This is illustrated by the spray of fluid, which is generally illustrated by reference number 48.

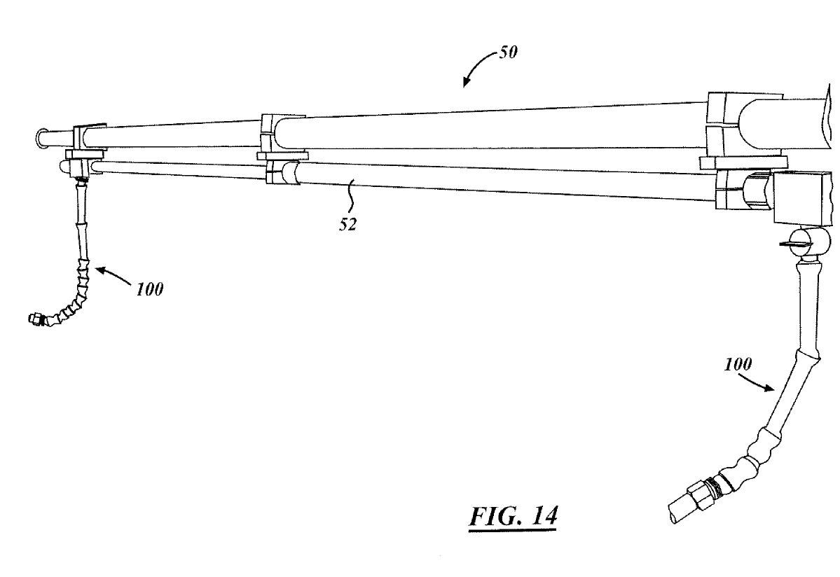

FIG. 14 illustrates and exemplary use for the applicator 10 of the present invention in a vehicle wash application. FIG. 14 illustrates a rain arch 50 having a pair of applicators 100. The rain arch 50 is configured such that a vehicle will travel underneath and be sprayed with water falling through openings in a conduit 52 that spans the length of the rain arch 50. Each applicator 100 is disposed at either end of the conduit 52. In this embodiment, the applicators 100 are intended to spray water onto the side view mirrors of a vehicle passing thereby to remove any soap that may accumulate in the mirror housing as tends to happen with current vehicle wash systems.

In this embodiment, the applicators 100 each include a flexible coupling 102 having an increased number of adjustment points to allow for adjustment of the applicators 100 in the same fashion discussed above. However, the increased number of adjustment points together with the increased lengths of the sleeves allows for a longer travel adjustment in height and angle than in the prior embodiment.

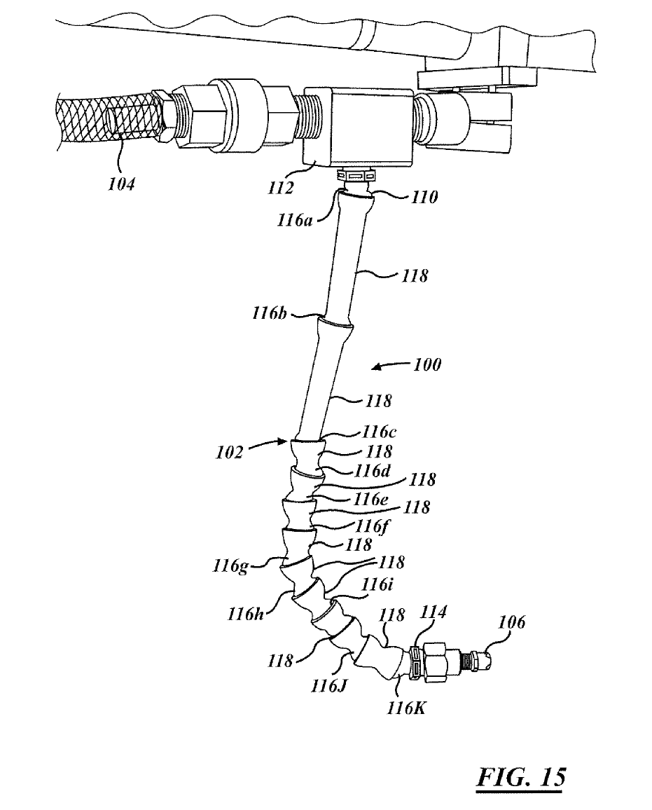

FIG. 15 illustrates one of the applicators 100 illustrated in FIG. 14. As shown, the applicator 100 includes a supply conduit 104, and a nozzle 106. The flexible coupling 102 attaches at one end 110 to a manifold 112 and at the other end 114 to the nozzle 106. The flexible coupling 102 includes a plurality of points of adjustment 116a-116k. Each of these points of adjustment can be independently and individually adjusted to change the height and the angle of the applicator 100 and the nozzle 106. Further, some of the sleeves 118 have different lengths to assist in optimizing the adjustment process.

It will be understood that that applicators 100 can be utilized for a variety of different purposes in the vehicle wash application and can be directed to wash, soap or dry various parts of a vehicle. Further, the lengths and orientations of the sleeves can vary. However, they need to be rigid enough to support the nozzle, once it has been oriented in a particular position by the operator. Moreover, the number of adjustment points can be increased or decreased.

While particular embodiments of the invention have been shown and described, numerous variations and alternate embodiments will occur to those skilled in the art. Accordingly, it is intended that the invention be limited only in terms of the appended claims.

What is claimed is:

1. A spray applicator system for a vehicle wash system, comprising:
a supply conduit in communication with a supply of fluid or gas at a first end and having a second end opposing said first end;
a nozzle having an inlet in communication with said second end of said supply conduit; a flexible coupling for attaching said nozzle to said supply conduit;
at least one orifice formed on said nozzle for emitting said fluid or gas received from said supply of fluid or gas therethrough;
whereby said flexible coupling allows said nozzle to be adjusted through multiple degrees of freedom without shutting off the flow of fluid or gas through said at least one orifice.

2. The spray applicator system of claim 1, further comprising:
a plurality of nozzles in communication with said supply of fluid or gas, each of said plurality of nozzles including at least one orifice and wherein each of said nozzles are independently manually adjustable through multiple degrees of freedom without shutting off the flow of fluid or gas through said at least one orifice.

3. The spray applicator system of claim 1, wherein said supply of fluid or gas is a foam solution and wherein said supply conduit includes a foam generator therein.

4. The spray applicator system of claim 1, wherein said flexible coupling has at least one point of adjustment allowing manual manipulation of said nozzle through multiple degrees of freedom at said at least one point of adjustment.

5. The spray applicator system of claim 4, wherein said flexible coupling consists of a ball fitting disposed within a sleeve and wherein manual manipulation consists of moving said ball fitting with respect to said sleeve.

6. The spray applicator system of claim 1, wherein said flexible coupling has a plurality of points of adjustment allowing manual manipulation of said nozzle through multiple degrees of freedom at each of said plurality of points of adjustment.

7. The spray applicator system of claim 1, wherein said nozzle includes a curved face in which said at least one orifice is formed.

8. The spray applicator system of claim 1, wherein said flexible coupling allows said nozzle to be manipulated without the use of tools and without the need to shut off the flow through said at least one orifice.

9. A spray applicator system for a vehicle wash system, comprising:
a plurality of supply conduits each in communication with a supply of fluid or gas at a first end;
a nozzle head secured to a respective second end of each of said plurality of supply conduits by a respective adjustment mechanism;
at least one orifice formed in a respective face of each of said plurality of nozzle heads for emitting said fluid or gas therethrough;
wherein said adjustment mechanism allows said nozzle head to be moved through at least one point of adjustment manually without requiring the shut off of flow through said at least one orifice.

10. The spray applicator of claim 9, wherein said supply of fluid or gas is a foam solution which passes through a foam generator in each of said plurality of supply conduits prior to passing through said associated nozzle head.

11. The spray applicator of claim 9, wherein each said respective adjustment mechanism consists of a ball fitting disposed within a rigid sleeve and wherein manipulation of said nozzle head is accomplished by moving said ball fitting with respect to said sleeve.

12. The spray applicator of claim 9, wherein each said respective adjustment mechanism includes a plurality of points of adjustment allowing manual manipulation of said nozzle head through multiple degrees of freedom at each of said plurality of points of adjustment.

13. The spray applicator of claim 12, wherein each of said plurality of points of adjustment consists of a ball fitting disposed within opposing ends of a rigid sleeve and wherein manipulation of said nozzle head is accomplished by moving each of said ball fittings with respect to said sleeve.

14. The spray applicator of claim 9, wherein each of said nozzle heads includes a curved face to allow the flow through said plurality of orifices to be directed at varying locations.

15. The spray applicator of claim 9, further comprising:
a plurality of adjustment mechanism connecting said second end of each of said supply conduits to said nozzle head.

16. A spray applicator system for a vehicle wash system, comprising:
at least one supply conduit in communication with a supply of fluid or gas at a first end,
a nozzle head in communication with a second end of said supply conduit, said nozzle head having at least one orifice formed therein for emitting said fluid or gas therethrough;
at least one adjustment mechanism connecting said nozzle head to said at least one supply conduit, said at least one adjustment mechanism having at least one point of adjustment to allow manual manipulation of said nozzle head to properly direct the flow through said at least one orifice without needing to shut off the flow through said orifices.

17. The spray applicator system of claim 16, further comprising:
a plurality of nozzle heads in communication with said supply of fluid or gas, each of said nozzle heads being coupled to said supply of fluid or gas by at least one adjustment mechanism that allows for independent adjustment of each of said nozzle heads through multiple degrees of freedom without the need to shut off the flow through said nozzle head.

18. The spray applicator system of claim 17, wherein said at least one adjustment mechanism consists of a ball fitting disposed within a rigid sleeve and wherein manual adjustment consists of moving said ball fitting with respect to said sleeve.

19. The spray applicator system of claim 16, wherein said at least one adjustment mechanism includes a plurality of points of adjustment allowing manual manipulation of said nozzle head through multiple degrees of freedom at each of said plurality of points of adjustment.

20. The spray applicator system of claim 16, wherein said at least one adjustment mechanism can be readily adjusted without the need for any tools.
